(19) United States
(12) Patent Application Publication
(10) Pub. No.: US 2010/0236639 A1
(43) Pub. Date: Sep. 23, 2010

(54) System And Method For Accessing A Pressurized Gas Pipeline

(75) Inventors: G. Gregory Penza, Setauket, NY (US); Dennis Teehan, Wallkill, NY (US); Hermann H. Herrlich, Lindenhurst, NY (US); George Lohr, Commack, NY (US)

Correspondence Address: BROOKS KUSHMAN P.C., 1000 TOWN CENTER, TWENTY-SECOND FLOOR, SOUTHFIELD, MI, 48075, US

(73) Assignees: ULC ROBOTICS, INC., Bay Shore, NY (US); CONSOLIDATED EDISON COMPANY OF NEW YORK, INC., New York, NY (US)

(21) Appl. No.: 12/710,085

(22) Filed: Feb. 22, 2010

Related U.S. Application Data
(60) Provisional application No. 61/154,264, filed on Feb. 20, 2009.

(51) Int. Cl. B23B 41/08; F16L 55/124

(52) U.S. Cl. 137/15.15; 137/15.12; 138/93; 137/320

(57) ABSTRACT

A system and method for inhibiting gas release while accessing a pressurized gas pipeline includes a magnetic plug holder for magnetically engaging a pipe plug to a rod. A housing is sealingly engaged to a valve attached to the pipeline, and the rod is movable through the housing in a sealing fashion such that the plug holder can be moved linearly and rotationally relative to the housing. The housing can be sealingly attached to a portion of the valve, the valve can be opened, and the plug holder with a threaded plug magnetically engaged thereto lowered through the valve. The rod can be rotated from outside the housing to thread the plug into the threaded hole in the pipeline.

### CROSS-REFERENCE TO RELATED APPLICATIONS

This application claims the benefit of U.S. provisional patent application Ser. No. 61/154,264, filed on 20 Feb. 2009, which is hereby incorporated herein by reference.

### TECHNICAL FIELD

The present invention relates to a system and method for accessing a pressurized gas pipeline.

### BACKGROUND

There are currently a number of systems available and in use for drilling and tapping a pressurized gas pipeline. One such system is known as the “ALH system-one”, and another is known as the “Mueller B-101”. The drilling and the tapping of the access hole into the gas pipeline is often just the first step in what is usually a much more involved maintenance procedure. For example, it may be desirable to install a service tee into the pipeline for later access by a service technician. In other situations, it may be necessary to insert and deploy a balloon stopper into the pipeline to completely cutoff the flow of gas downstream from the stopper. In an even more complicated maintenance procedure, it may be necessary to install a bypass pipe around a portion of the pipeline that requires maintenance, and then install two balloon stoppers just inside the bypass pipe so that the flow of gas can continue both upstream and downstream from where the stoppers are deployed and the maintenance is being performed. In such a case, it may be necessary to drill and tap four separate holes in the pipeline—two holes to accommodate the bypass line, and two holes to accommodate the two balloon stoppers. Maintenance is then performed between the two balloon stoppers, where the flow of gas is completely shutoff.

It is common practice in the utility industry to allow gas to escape from the pipeline into the atmosphere when installing a bypass line or balloon stoppers as described above. This procedure can result in a loss of downstream pressure, to the point where pilot lights in appliances go out, and have to be relit after the flow of gas returns to a normal pressure. This can be a particular problem in the north during the winter months, when furnaces and hot water heaters are running almost constantly.

In addition to the disruption and service to customers, the release of gas from the pipeline into the atmosphere is an unwanted source of additional green house gases which can have a detrimental effect on the environment. Moreover, the release of gas from the pipeline while the service technicians are performing maintenance can pose safety concerns related to inhalation and potential explosion of the released gas. Therefore, a need exists for a system and method for inhibiting the release of gas from a pressurized gas pipeline while accessing the pipeline.

### SUMMARY

Embodiments of the present invention provide a method for inhibiting gas release while accessing a pressurized gas pipeline. In one embodiment, the pipeline has a threaded hole through the wall of the pipeline that provides access from an ambient environment outside the pipeline into the interior of the pipeline. A valve covers the threaded hole, and is attached on an outside of a pipeline. The valve has an open position for facilitating access to the threaded hole from outside the pipeline, and a closed position for sealingly covering the threaded hole to inhibit gas transfer from inside the pipeline to an ambient environment outside the pipeline. As used herein, the term “inhibiting” means that the transfer of gas is generally prohibited; however, it is understood that even under tightly controlled conditions, some minute quantities of gas may still escape, and as such gas escape is not completely prohibited. It is worth noting, however, that the quantity of gas entering the atmosphere can be reduced by orders of magnitude through proper implementation of embodiments of the present invention.

The method described above includes the step of magnetically engaging a magnetic pipe plug holder and a threaded pipe plug, which is sized to be threaded into the threaded hole in the pipeline. A sealing member, or housing, is provided for the pipe plug and pipe plug holder, and it is configured in such a way as to allow sealed movement of the pipe plug holder, and therefore the magnetically engaged pipe plug, in both a linear and rotational fashion. One way in which the pipe plug holder can be linearly or rotationally moved relative to the housing while still maintaining a gas seal, is to provide a rod that extends through another sealing member, or sealed bushing, in the housing. The end of the rod may have a female portion adapted to receive a shank of the magnetic plug holder.

The method described above may also include the step of sealingly engaging the housing to a portion of the valve that is positioned on the pipeline. The valve is then opened, and the magnetically engaged pipe plug is disposed through the open valve and into the threaded hole. Rotating the rod from outside of the housing causes the pipe plug holder, and hence the magnetically engaged pipe plug, to be rotated and threaded into the hole in the pipeline. The pipe plug holder can then be extracted from the pipe plug by linearly moving the rod away from the pipe plug such that the magnet disengages. The housing can then be removed from the valve, and the gas pipeline has been plugged while gas escape into the atmosphere has been inhibited.

Embodiments of the invention may include an access port in the housing having a vent valve disposed therein, where the vent valve can be opened and closed as desired. The access port may have a very small diameter such that if gas were to escape from the pipeline through the housing and out of the vent valve, it would be a very slow process that could be quickly stopped before any undesirable quantity of gas escaped. After the pipe plug is threaded into the hole in the gas pipeline, the vent valve can be opened prior to removing the housing from the pipeline. In this way, it can be determined whether the insertion of the pipe plug, which is not visible to the pipeline technician, was inserted correctly and has provided a seal to keep gas from escaping from the pipeline. A small quantity of gas may be in an interior portion of the housing, even if the pipe plug has been inserted correctly. Therefore, once the access port is opened, a technician can determine whether a certain amount of gas is exiting through the port, which would indicate a poor seal between the pipe plug and the pipeline. If this occurs, the access port can be closed, and the pipe plug rethreaded into the pipeline.

As noted above, installing a threaded plug into a pipeline is often the first step of a much larger maintenance procedure, which may include installing a bypass line, a service tee, or one or more balloon stoppers into the pipeline. To address this situation, embodiments of the present invention include installing a strap saddle on an outside of the pipeline such that an opening in the saddle is generally aligned with the pipe plug. Strap saddles of this type will provide a seal against an outside surface of the pipeline generally around the installed pipe plug. A valve is then attached to the saddle, although it may require one or more threaded adapters, nipples, reducers, etc. to effect this attachment. Any number of different types of valves can be used in a method such as this, including pancake valves, globe valves, or any other valve that will allow access to the threaded plug and will sealingly engage the strap saddle such that closing the valve when the pipe plug is removed will effectively stop gas from leaking from the pipeline.

Embodiments of the present invention include the reversal of some of the steps used to insert the pipe plug into the pipeline. For example, after the strap saddle and valve are attached to the pipeline, a magnetic plug holder can be disposed inside a housing, which is then sealingly attached to a portion of the valve. The valve can then be opened and the magnetic plug holder lowered through the valve and onto the pipe plug that is threaded into the gas pipeline. Rotating a shaft that extends through the housing will rotate the threaded plug until it can be removed from the pipeline. The magnetic plug holder magnetically engages the plug, and as the shaft is lifted, the plug holder and plug exit the valve, which is then closed to form a seal to the outside atmosphere. The housing can then be removed from the valve.

At this point, it may be desirable to install a balloon stopper into the pipeline to stop the flow of gas downstream from the stopper. Embodiments of the present invention include a sealing member, or sealing adapter, that is configured to sealingly engage a launch tube that is part of a balloon stopper system. The sealing adapter can be sealingly engaged with the launch tube, and then sealingly attached to a portion of the valve. For example, one such sealing adapter can be a threaded bushing specifically configured with an interior seal or seals that are sized to allow the launch tube to slide through the bushing, while sealing to an interior seal or seals within the bushing. The bushing can then be threaded into a female threaded portion of the valve, the valve can be opened, and the launch tube inserted through the valve and threaded into the threaded hole in the pipeline, all while escape of gas from the interior of the pipeline is inhibited. The balloon stopper can then be deployed in the pipeline to stop the flow of gas through the pipeline.

The sealing adapter can be part of a system of the present invention which can include one or more apparatuses specifically configured to provide for accessing and installing devices into a pressurized gas pipeline while inhibiting the escape of gas from the pipeline into the atmosphere. Embodiments of a system of the present invention can include a magnetic plug holder that has a receiving portion configured to mate with a portion of a pipe plug such that rotation of the plug holder rotates the pipe plug. The magnetic plug holder can also include an attachment portion for attaching the plug holder to a shaft such that rotation of the shaft rotates the attachment portion and the receiving portion. In some cases, a pipe plug may have a projecting head that can be square, hexagonal, or some other geometric shape. In such cases, the receiving portion of the magnetic plug holder can be configured with a recess that is sized and shaped to receive the projecting head of the pipe plug. In other situations, the pipe plug itself may have a recess, in which case, the receiving portion of the plug holder may include a projection configured to fit inside of the recess in the pipe plug.

Embodiments of the present invention can also include a hand cylinder that has a number of elements, such as a first elongate member, which can be, for example, a holder rod. This rod can be configured to be inserted into a housing in a sealing fashion such that the rod can be moved linearly and rotationally inside the housing, while maintaining a seal that would inhibit the escape of gas from inside the housing to outside the housing. The system can also include an adapter configured for attachment to one end of the holder rod and further configured to engage the magnetic plug holder. The adapter is sized to be moveable through an interior of the housing, such that when the housing is sealingly engaged with the valve and the plug holder is attached to the adapter and magnetically engaged with the pipe plug, the pipe plug can be linearly disposed through the valve by linear movement of the holder rod, while escape of gas from the pipeline is inhibited.

### BRIEF DESCRIPTION OF THE DRAWINGS

FIG. 1 shows an embodiment of a system of the present invention used to remove a plug from a gas pipeline;

FIGS. 2A and 2B illustrate a magnetic plug holder portion of the system shown in FIG. 1;

FIGS. 3A and 3B show a holder rod portion of the system shown in FIG. 1;

FIGS. 4A and 4B show a plug holder adapter portion of the system shown in FIG. 1;

FIGS. 5A and 5B show a housing portion of the system shown in FIG. 1;

FIGS. 6A and 6B show a bushing used with the housing shown in FIGS. 5A and 5B;

FIGS. 7A and 7B show a rod handle portion of the system shown in FIG. 1;

FIGS. 8A and 8B show a rod handle adapter configured to connect the holder rod shown in FIGS. 3A and 3B and the rod handle shown in FIGS. 7A and 7B;

FIG. 9 shows an embodiment of the present invention configured to allow deployment of a balloon stopper into a pressurized gas pipeline while the release of gas is inhibited;

FIGS. 10A and 10B show a threaded bushing portion of the system illustrated in FIG. 9; and

FIG. 11 illustrates threaded bushings such as shown in FIGS. 10A and 10B in use with balloon stoppers and a bypass line for maintenance on a pressurized gas pipeline.

### DETAILED DESCRIPTION

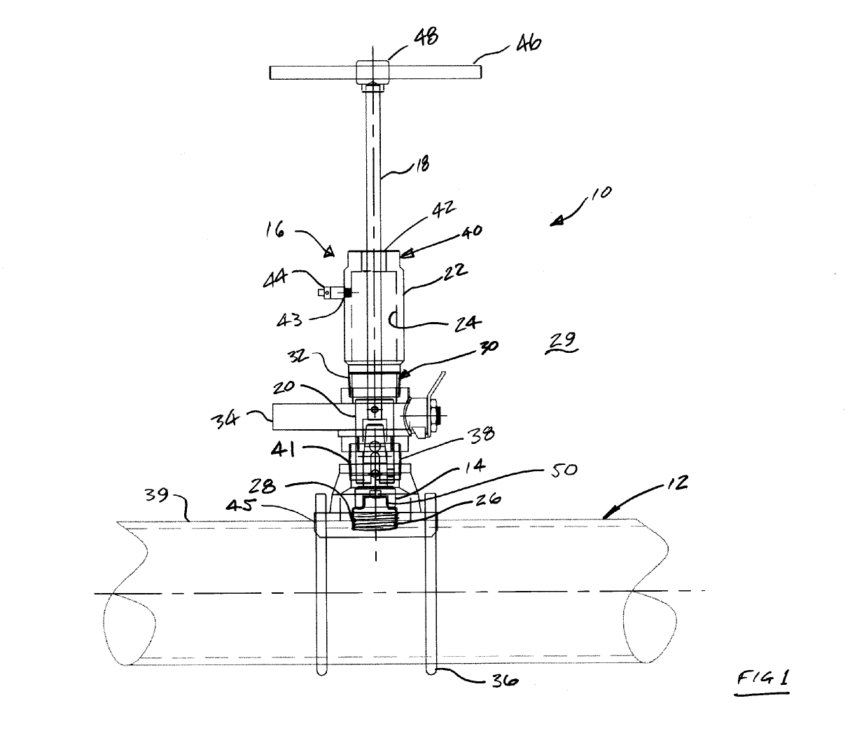

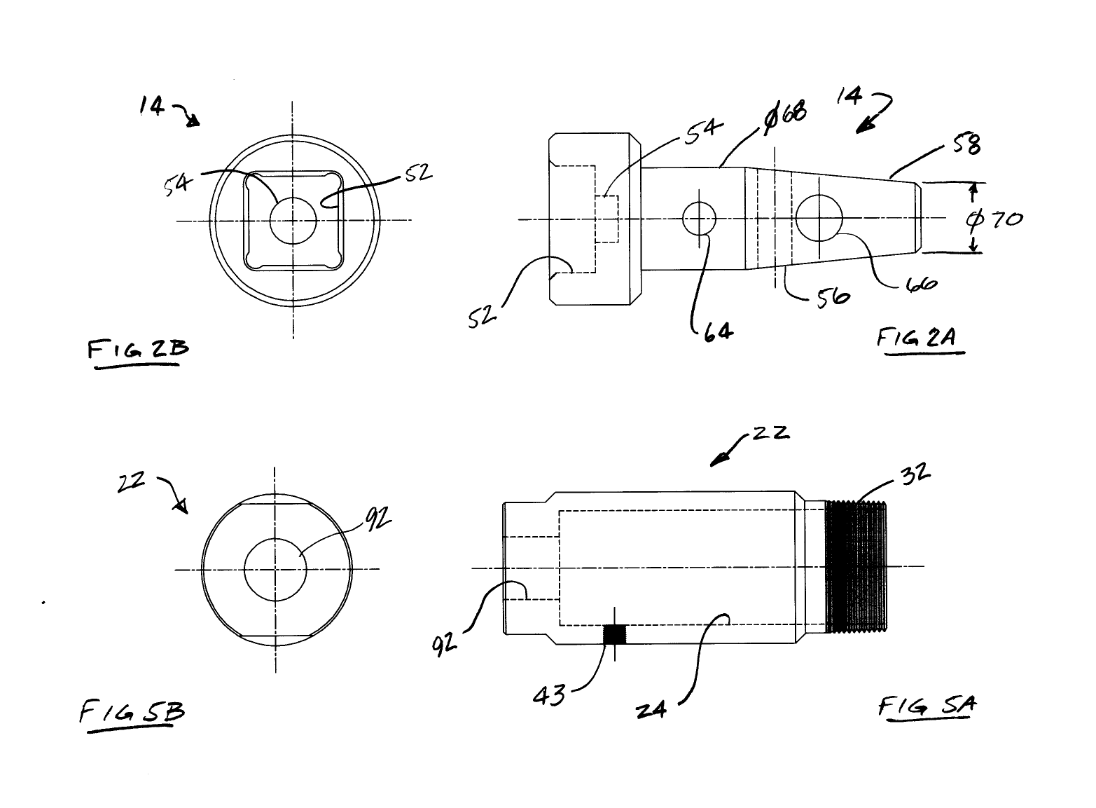

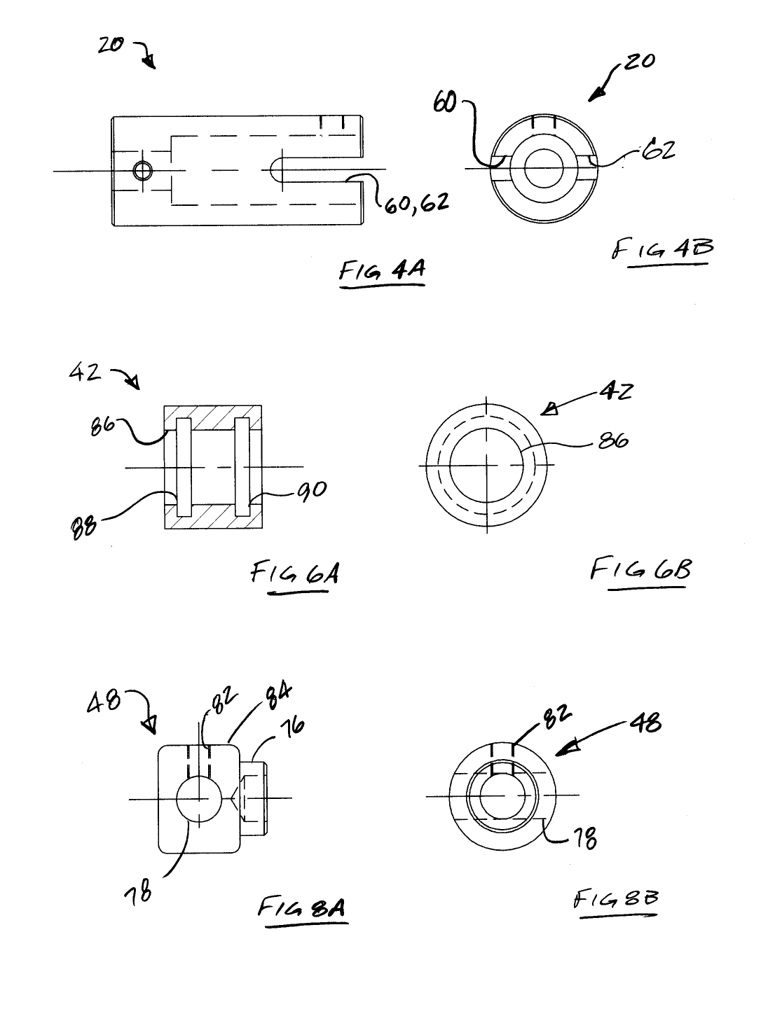

FIG. 1 shows a system 10 for inhibiting gas release while accessing a pressurized gas pipeline 12. The system 10 includes a magnetic plug holder 14, which is shown in more detail in FIGS. 2A and 2B. The system 10 also includes a hand cylinder 16, which in the embodiment shown in FIG. 1 includes a number of different components. The hand cylinder 16 includes a first elongate member, or holder rod 18. The rod 18, shown in more detail in FIGS. 3A and 3B, has attached to one end an adapter 20. The adapter 20 is shown in detail in FIGS. 4A and 4B, and it is configured to engage the plug holder 14, as shown in FIG. 1.

The hand cylinder 16 also includes a housing 22, which in one embodiment may be generally configured as a right circular cylinder as shown in detail in FIGS. 5A and 5B. The housing 22 may have an overall length of approximately 7 inches, and an outside diameter of around 2.5 inches. The rod 18 is configured to be linearly and rotationally movable relative to the housing 22, which has an interior portion 24 that is large enough to receive the adapter 20 when the rod 18 is pulled in an upward direction as the hand cylinder 16 is oriented in FIG. 1. In one embodiment, the interior portion may have a length of approximately 6 inches, and an inside diameter of approximately 2 inches.

One of the advantages of the system 10 is that it allows a device such as a pipe plug 26 to be inserted into and removed from a threaded hole 28 that is disposed in the pipeline 12, while inhibiting the release of gas from the pressurized pipeline 12 to an ambient environment 29 outside the pipeline 12. In some applications, a gas pipeline, such as the pipeline 12, may provide gas to many customers, even though it operates at a relatively low pressure, such as one pound per square inch (psi) or less. Although it works very well for such applications, the system 10 can also work in applications where the gas is much more highly pressurized, for example, at or near 60 psi. In order to inhibit the release of gas while the plug 26 is being inserted or extracted, the system 10 includes a number of features. For example, one end 30 of the housing 22 includes tapered pipe threads 32 that provide a sealing engagement with a slide valve 34 that is attached to a strap saddle 36 by a nipple 38.

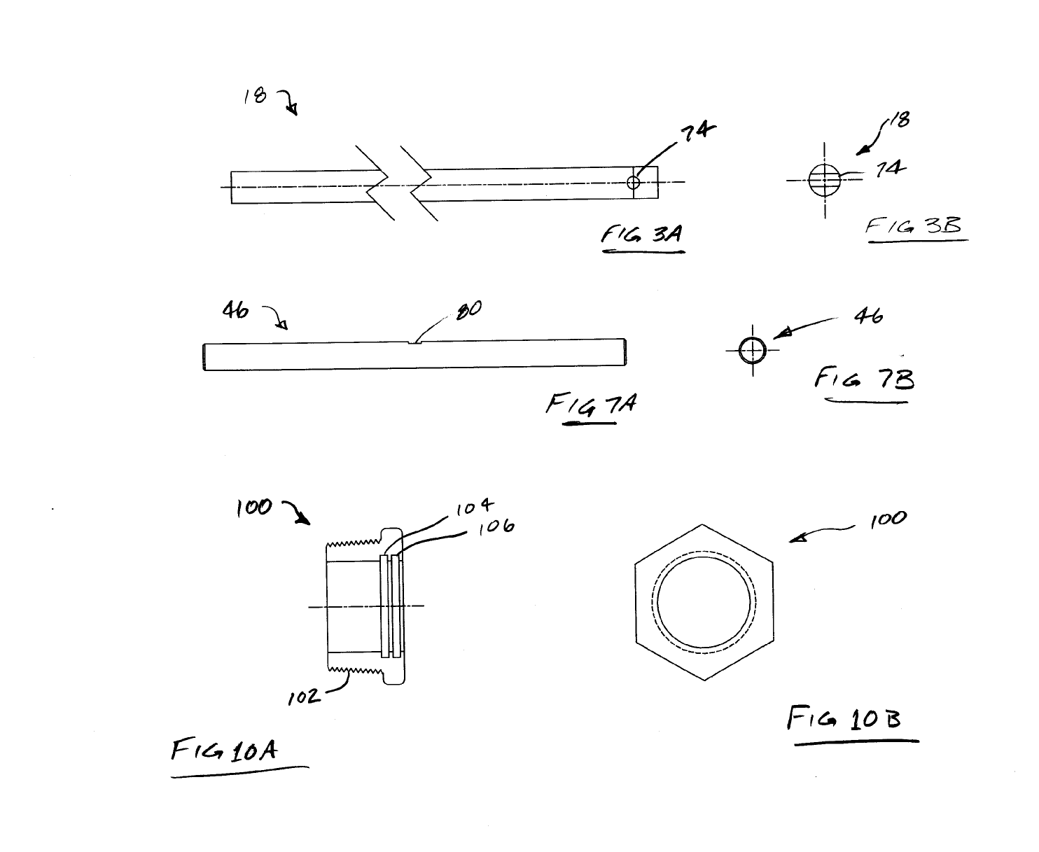

The strap saddle 36 is attached to an outside 39 of the pipeline 12 such that an opening 41 in the saddle 36 is generally aligned with the pipe plug 26 in the pipeline 12. A portion 45 of the saddle 36 sealingly engages the outside 39 of the pipeline 12. In order to keep gas from escaping from the other end 40 of the housing 22, a bushing 42 is provided between the housing 22 and the rod 18. The bushing 42 is shown in more detail in FIGS. 6A and 6B. The housing 22 also includes an access port 43 having a vent 44 disposed therein. As explained below in conjunction with a method of the present invention, the vent 44 helps to ensure that the plug 26 is properly seated and sealed against the pipeline 12 prior to disengagement of the housing 22 from the valve 34. In order to facilitate linear and rotational movement of the rod 18, and therefore the plug holder 14 and the pipe plug 26, the hand cylinder 16 also includes a rod handle 46, which is attached to the rod 18 with a rod handle holder 48. The rod handle 46 is shown in detail in FIGS. 7A and 7B, while the rod handle holder 48 is shown in FIGS. 8A and 8B.

Referring to FIGS. 1-8, a method of the present invention is now described in detail. Shown in FIG. 1 is the system 10 set up to extract the plug 26 from the hole 28 in the pipeline 12. The initial insertion of the plug 26 into the pipeline 12 is described below. In order to remove the plug 26 from the pipeline 12 while inhibiting the release of gas from the pipeline 12 to the atmosphere, the hand cylinder 16 is sealingly engaged to the valve 34 before the valve 34 is opened. The plug holder 14 is inside the housing 22 and ready to be lowered through the valve 34 when it is opened. As shown in FIG. 1, the plug holder 14 is magnetically engaging the plug 26. The plug holder 14 can be adapted to accommodate different sizes of plugs, and different configurations. For example, the plug 26 has a projection, or head 50. The head 50 may be hexagonal, or of some other shape, although such plugs very often have a square head. Turning to FIG. 2A, it is shown that the plug holder 14 includes a receiving portion 52 which in the embodiment shown in FIG. 2A is a square recess configured to receive the head 50 of the plug 26.

The recess 52 may be approximately 0.83 inches square to accommodate a standard 1 inch pipe plug. Similarly, it can be made larger such as 0.96 inches for a 1¼ inch plug, or 1.15 inches for a 1½ inch plug. Of course, different sizes and configurations of a recess, such as the recess 52, are contemplated in order to accommodate different types of pipe plugs. In addition, although the receiving portion 52 is illustrated as a recess, it could be, for example, a projection, to accommodate a pipe plug having a recess, instead of a projecting head.

The plug holder 14 also includes a magnet 54, which may be, for example, a 6 pound magnet, which is strong enough to lift standard sized pipe plugs, while still making it relatively easy to disengage the plug holder 14 from the pipe plug. The plug holder 14 also includes an aperture 56 transversely disposed through an attachment portion, which in the embodiment shown in FIG. 2A, is a shank 58. The aperture 56 is configured to receive a pin that is inserted to extend beyond the edges of the shank 58, and thereby cooperate with slots 60, 62 in the plug holder adapter 20—see FIGS. 4A and 4B. This allows the plug holder 14 to rotate when the plug holder adapter 20 is rotated by a service technician turning the rod handle 46, shown in FIG. 1. Returning to FIG. 2A, it is shown that the plug holder 14 also includes apertures 64, 66, which may or may not be through-holes, and which are configured to receive a set screw or other connecting device to hold the plug holder 14 to the plug holder adapter 20. As shown in FIG. 2A, the shank 58 may have a maximum diameter 68 of 1.1 inches, which tapers to a diameter 70 of 0.75 inches. Although these approximate dimensions can be changed to accommodate various sizes of plug holder adapters, this range of sizes has been shown to fit existing drilling and tapping systems, such as the Mueller B-101 system as described below.

Returning to FIG. 1, the method of extracting the pipe plug 26 is now continued. Once the plug holder 14 magnetically engages the pipe plug 26, a service technician can rotate the rod handle 46 to unthread the plug 26 from the hole 28 in the pipeline 12. The rod handle 46 is then pulled upward such that the plug holder 14 and plug 26 travel through the open valve 34 and into the interior 24 of the housing 22. The valve 34 is then actuated to a closed position. The vent 44 can then be opened slightly to monitor the amount of gas leaving the housing 22 to determine if the valve 34 was successfully closed, and the release of gas from the pipeline 12 is inhibited. Although there may be a small amount of gas within the interior 24 of the housing 22 that is released when the vent 44 is opened, any released gas will quickly dissipate if the valve 34 is closed. In contrast, if the valve 34 is not properly closed, then gas will continue to escape through the valve 34 into the housing 22, and through the vent 44 into the atmosphere. Thus, a service technician can readily determine if the valve 34 was not properly closed. In such a case, the vent 44 can then be closed, while the valve 34 is opened and re-closed to try to properly seat the valve mechanism to ensure that gas does not escape from the pipeline 12. At this point, the threaded end 30 of the housing 22 can be disengaged from the valve 34 and additional work performed on the pipeline 12.

The method discussed above describes the steps of using the system 10 to remove a pipe plug from a pipeline, such as the pipeline 12. The system 10 can also be used to insert a pipe plug, by reversing the steps described above. In addition, the system 10 can also be used to insert a pipe plug immediately after a threaded hole has been drilled and tapped into a pipeline, such as the pipeline 12. For example, both the ALH system-one and the Mueller B-101 have a valve that can be opened and closed to drill and tap a pipeline without releasing gas into the atmosphere. The magnetic plug holder 14 of the present invention is configured for attachment to a portion of the Mueller B-101 system after the drill and tap head is removed. In this way, a pipe plug, such as the plug 26 shown in FIG. 1, can be quickly inserted into the newly tapped and drilled hole without expending much time in system changeovers.

Similarly, the system 10 can also be used with the ALH system-one by sealingly connecting the housing 22 to an adapter connected to the valve already present in the ALH system-one. Insertion and extraction of a pipe plug using the present invention provides a fast and efficient mechanism for what is very often a first step in a much larger pipeline maintenance program. As described below, some maintenance procedures, such as installing a bypass line and balloon stoppers, require the drilling and tapping of many holes. Thus, the advantages of inhibiting gas release by using the system and method of the present invention can be multiplied many times for a single maintenance operation.

Looking at some of the details of the components of the system 10, the holder rod 18 shown in FIGS. 3A and 3B may have a length of approximately 16 inches and a diameter of approximately 0.625 inches. An aperture 74 is disposed transversely through one end of the holder rod 18 to accommodate attachment of the rod handle holder 48 shown in FIGS. 8A and 8B. A set screw (not shown) can be disposed through a collar portion 76 of the rod handle holder 48. A through-hole 78 is sized to accommodate the rod handle 46 shown in FIGS. 7A and 7B. The rod handle 46 may have a diameter of approximately 0.625 inches, which accommodates the through-hole 78 in the rod handle holder 48. A small indentation 80 may be included in the rod handle 46 to accommodate a set screw that can be disposed through a threaded hole 82 and a head portion 84 of the rod handle holder 48—see FIG. 8A.

As discussed above, the system 10 is configured such that the rod 18 can be move linearly and rotationally through the housing 22 while the release of gas from inside the pipeline 12 is inhibited. To help accommodate this, a bushing 42, shown in FIGS. 6A and 6B, is configured to be inserted into the housing 22, and to receive the rod 18 through an aperture 86. As shown in FIG. 6A, the aperture 86 includes two O-ring grooves 88, 90. Alternatively, an O-ring could be sandwiched between the ends of two bushings that do not have any O-ring grooves, and these two bushings could be press-fit into the aperture 92 in the housing 22 as shown in FIG. 5A. The bushing 42 is also configured to be press-fit into the aperture 92, and in one embodiment may have an outside diameter of approximately 1.25 inches, while in another embodiment have an outside diameter of approximately 1.125 inches. The aperture 92 is then sized accordingly for a sealing fit between the outside of the bushing and the inside of the aperture 92. It is understood that each of the components described in the system 10 can have dimensions that vary according to the particular application, for example, larger diameters and sizes to accommodate larger pipe plugs, or smaller diameters in sizes to accommodate smaller pipe plugs.

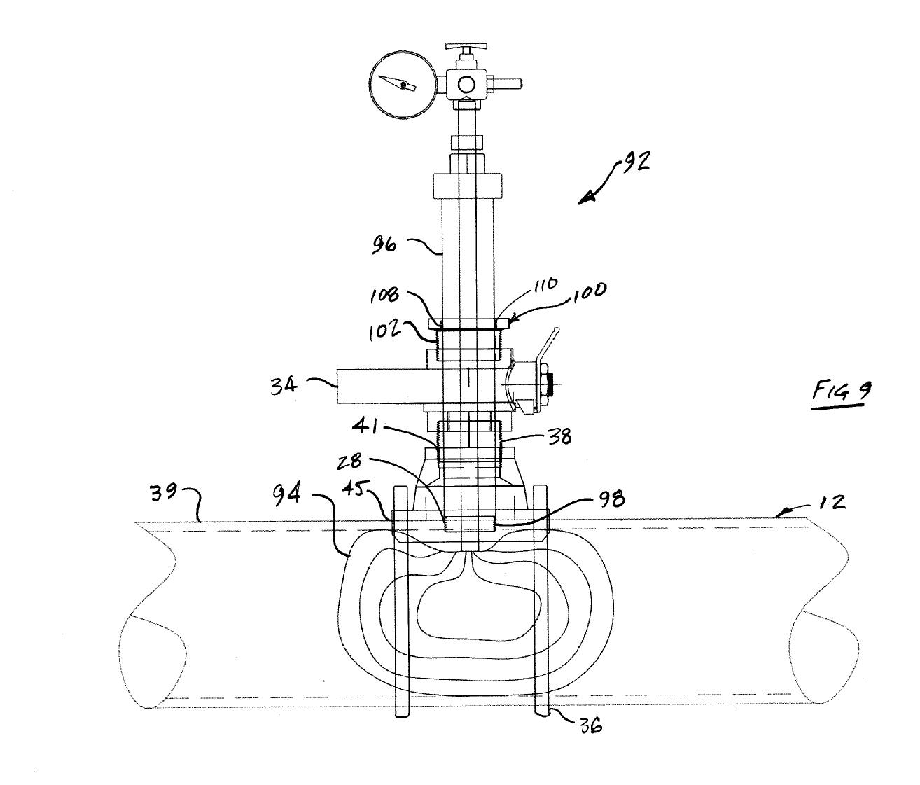

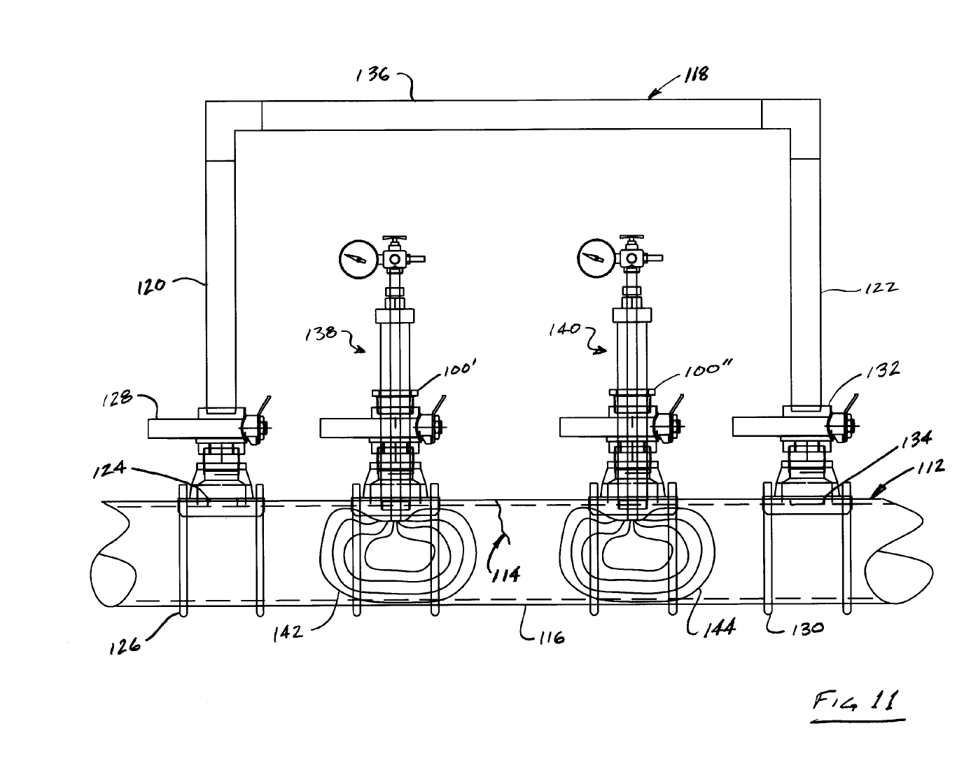

As mentioned above, installing or removing a pipe plug is often only the first step in a larger pipeline maintenance program. For example, it may be desirable to install a balloon stopper in a gas pipeline to stop the flow of gas to a particular portion of the pipeline. FIG. 9 illustrates a balloon stopper system 92 having a balloon stopper 94 installed in the pipeline 12 after the plug 26 has been removed. The balloon stopper 94 may be installed, for example, by attaching the strap saddle 36 to the outside 39 of the pipeline 12 as described above. The balloon stopper system 92 includes a launch tube 96 having a threaded end 98 that is configured to be threaded into the threaded hole 28 of the pipeline 12. To deploy the balloon stopper 92, it is common practice to remove the plug 26 without a system, such as the system 10, thereby allowing gas to escape until the threaded end 98 of the launch tube 96 can be secured to the pipeline 12. The system 10, however, further provides for deploying a balloon stopper, such as the balloon stopper 94, while inhibiting the release of gas from the pipeline 12.

The system 10 further includes a threaded bushing 100 that is shown in detail in FIGS. 10A and 10B. The bushing 100 includes tapered pipe threads 102 configured to sealingly engage the valve 34 similar to the housing 22 as illustrated in FIG. 1. As best illustrated in FIG. 10A, the bushing 100 includes two O-ring grooves 104, 106, configured to receive O-rings that will cooperate with the launch tube 96 to keep gas from escaping from the pipeline 12 even when the valve 34 is open. FIG. 9 shows O-rings 108, 110 sealingly engaging the launch tube 96 to inhibit the release of gas from the pipeline 12. As shown in FIG. 9, the threaded end 98 of the launch tube 96 is already secured to the pipeline 12; however, during insertion and extraction of the threaded end 98, gas would be released to the atmosphere without the addition of the threaded bushing 100 as part of the system 10.

FIG. 11 shows a partially schematic representation of the kind of pipeline maintenance that often must be performed on a pressurized gas pipeline. As shown in FIG. 11, a pipeline 112 includes a crack 114. In order to replace the cracked section 116 of the pipeline 112, the flow of gas must be cut off to the section 116. It is often impractical or even impracticable to shut off the gas flow at a gas main, which would cut off service to every customer downstream of the gas main. To provide continuous gas service to customers, while still providing a gas-free service area for the technicians, a bypass line 118 is installed around the cracked section 116 of the pipeline 112.

Using embodiments of the present invention, the bypass 118 may be installed while release of gas from the pipeline 112 is inhibited. In particular, first and second sections, or risers 120, 122, of the bypass line 118 can be installed by a method that uses the present invention to inhibit gas release. For the riser 120, a hole 124 is drilled and tapped in the pipeline 112, for example, using a known drill and tap system. A pipe plug (not shown) can then be installed in accordance with a method of the present invention as described above. The drilling and tapping apparatus can be removed and a strap saddle 126 and valve 128 attached to the pipeline 112. The pipe plug can then be removed in accordance with a method of the present invention as described above, and the valve 128 closed. The riser 122 can be installed similarly, using a strap saddle 130 and valve 132 to cover a hole 134 in the pipeline 112. Once the risers 120, 122 are installed, a connecting section 128 can be installed. It is understood that in practice a number of different elbows, couplings, unions, or other sections of bypass pipe may be used to complete the connection.

In addition to installing the bypass 118, it is also necessary to install two separate balloon stopper systems 138, 140. Using a system and method of the present invention, such as described above, holes can be drilled and tapped for each of the balloon stopper systems 138, 140, and each of them can be inserted and their respective balloon stoppers 142, 144 deployed while at every step the release of gas from inside the pipeline 112 is inhibited. Each of the balloon stopper systems 138, 140 cooperates with a threaded bushing seal 100′, 100″ to effect a seal against a respective launch tube and inhibit gas release. Use of the system and method of the present invention provides a way to eliminate or severely reduce the escape of gas during pipeline maintenance operations, and therefore, reduce or eliminate the detrimental effects associated with the release of gas from a pipeline.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for inhibiting gas release while accessing a pressurized gas pipeline, the pipeline having a threaded hole therethrough and a threaded pipe plug threaded into the threaded hole to inhibit a transfer of gas from inside the pipeline to outside the pipeline, the method comprising:
installing a strap saddle on an outside of the pipeline such that an opening in the saddle is generally aligned with the pipe plug and at least a portion of the saddle sealingly engages the outside of the pipeline around the pipe plug;
attaching a valve to the saddle, the valve having an open position for facilitating access to the threaded hole from outside the pipeline, and a closed position for sealingly covering the threaded hole to inhibit gas transfer from inside the pipeline to outside the pipeline;
providing a housing sized to house a magnetic pipe plug holder, the housing including at least one seal to allow sealed linear and rotational movement of the plug holder from outside the housing;
inserting the plug holder into the housing;
sealingly engaging the housing having the plug holder therein to a portion of the valve;
actuating the valve to the open position;
inserting the plug holder through the open valve such that it magnetically engages the pipe plug;
unthreading the pipe plug from the threaded hole;
moving the magnetically engaged pipe plug through the open valve and into the housing;
closing the valve; and
removing the housing from the valve.

2. The method of claim 1, further comprising:
providing a vent on a portion of the housing, the vent having an open position for facilitating gas transfer between an interior of the housing and the outside of the housing, and a closed position for inhibiting gas transfer between an interior of the housing and the outside of the housing;
opening the vent after the step of closing the valve and prior to the step of removing the housing from the valve;
monitoring the amount of gas leaving the housing through the vent to determine if gas from the pipeline is leaking past the valve; and
closing the vent and opening and reclosing the valve if it is determined that gas from the pipeline is leaking past the valve.

3. The method of claim 1, further comprising deploying a balloon stopper into the pipeline to stop the flow of gas downstream from the balloon stopper, the balloon stopper including a launch tube configured for threaded attachment to the threaded hole in the pipeline, the step of deploying the balloon stopper comprising:
sealingly attaching a sealing adapter to a portion of the valve, the sealing adapter having an interior configured to receive and sealingly engage the launch tube;
sealingly engaging the launch tube with the interior of the sealing adapter;
actuating the valve to the open position;
inserting the launch tube through the open valve and threading the launch tube into the threaded hole in the pipeline; and
deploying the stopper in the pipeline through the launch tube.

4. A method for inhibiting gas release while accessing a pressurized gas pipeline, the pipeline having a threaded hole therethrough and a valve covering the threaded hole on an outside of the pipeline, the valve having an open position for facilitating access to the threaded hole from outside the pipeline, and a closed position for sealingly covering the threaded hole to inhibit gas transfer from inside the pipeline to outside the pipeline, the method comprising:
magnetically engaging a magnetic pipe plug holder and a threaded pipe plug sized for threading into the threaded hole;
providing a housing sized to house the magnetically engaged pipe plug therein, the housing including at least one seal to allow sealed linear and rotational movement of the magnetically engaged pipe plug from outside the housing;
sealingly engaging the housing to a portion of the valve;
actuating the valve to the open position;
inserting the magnetically engaged pipe plug through the open valve and into the threaded hole;
threading the magnetically engaged pipe plug into the threaded hole;
disengaging the pipe plug holder from the pipe plug such that the pipe plug holder exits the open valve and enters the housing; and
disengaging the housing from the valve.

5. The method of claim 4, further comprising:
providing a vent on a portion of the housing, the vent having an open position for facilitating gas transfer between an interior of the housing and the outside of the housing, and a closed position for inhibiting gas transfer between an interior of the housing and the outside of the housing;
opening the vent after the step of threading the magnetically engaged pipe plug into the threaded hole, and prior to the step of disengaging the housing from the valve;
monitoring the amount of gas exiting the housing through the vent to determine if gas from the pipeline is leaking past the pipe plug; and
closing the vent and rethreading the pipe plug into the threaded hole if it is determined that gas from the pipeline is leaking past the pipe plug.

6. The method of claim 4, further comprising:
sealingly inserting an elongate member through the housing, the elongate member being sized to extend through the housing and to cooperate with the at least one seal to inhibit gas release from the housing; and
attaching the pipe plug holder to the end of the elongate member,
the step of threading the magnetically engaged pipe plug into the threaded hole including moving the elongate member linearly and rotationally from outside the housing to thread the pipe plug into the threaded hole.

7. The method of claim 4, further comprising:
attaching an adapter to the end of the elongate member prior to attaching the pipe plug holder such that rotation of the elongate member rotates the adapter, the adapter being sized for attachment to the end of the elongate member and for receiving the pipe plug holder, thereby allowing different pipe plug holders to be attached to the end of the elongate member.

8. A system for inhibiting gas release while accessing a pressurized gas pipeline, the pipeline having a threaded hole therethrough sized to receive a threaded pipe plug therein to inhibit a transfer of gas from inside the pipeline to outside the pipeline, the system comprising:
an elongate member;
a sealing member configured to provide a seal between the threaded hole and the ambient environment outside the pipeline, the sealing member being sized to receive the elongate member therethrough, and including at least one seal to allow sealed linear and rotational movement of the elongate member when it is disposed through the sealing member; and
a magnetic pipe plug holder including:
a receiving portion configured to mate with a portion of the pipe plug such that rotation of the plug holder rotates the pipe plug, and
an attachment portion for attaching the plug holder to the elongate member such that rotation of the elongate member rotates the attachment portion and the receiving portion.

9. The system of claim 8, wherein the sealing member comprises a housing sized to house the pipe plug holder and a pipe plug held therein.

10. The system of claim 9, further comprising a vent disposed in the housing and having an open position and a closed position for selectively allowing fluid communication between an interior portion of the housing and an ambient environment outside the housing.

11. The system of claim 9, wherein the housing includes an interior portion having a length of approximately 6 inches, and an inside diameter of approximately 2 inches to receive the pipe plug holder and a pipe plug held in the pipe plug holder.

12. The system of claim 9, wherein the housing further comprises a bushing disposed therein and carrying the at least one seal to seal against the elongate member when the elongate member is disposed through the housing.

13. The system of claim 12, further comprising an adapter configured for attachment to one end of the elongate member and for receiving and holding the pipe plug holder, the adapter being sized to fit within the housing when the pipe plug holder and a pipe plug held in the pipe plug holder are disposed in the housing.

14. The system of claim 8, wherein the pipeline has a valve sealed against the pipeline and disposed between the threaded hole and an ambient environment outside the pipeline, the system further comprising a sealing member configured for sealing engagement to a portion of the valve and having an interior configured to receive and sealingly engage a launch tube of a balloon stopper.

15. The system of claim 8, wherein the receiving portion of the pipe plug holder is a recess sized and shaped to receive a projecting head of the pipe plug.

16. The system of claim 8, wherein the attachment portion of the pipe plug holder is a shank configured to mate with a female portion of the elongate member.
